(19) United States
(12) Patent Application Publication
(10) Pub. No.: US 2010/0144366 A1
(43) Pub. Date: Jun. 10, 2010

(54) Methods and systems for determining the location of a femtocell

(76) Inventors: Atsushi Ishii, Vancouver, WA (US); Kenneth J. Park, Cathlamet, WA (US)

Correspondence Address: SHARP LABORATORIES OF AMERICA, INC., 1320 PEARL ST., SUITE 228, BOULDER, CO, 80302, US

(21) Appl. No.: 12/315,651

(22) Filed: Dec. 5, 2008

(51) Int. Cl. H04W 24/00

(52) U.S. Cl. 455/456.1

(57) ABSTRACT

A femtocell acquires its geographic location using location samples reported by mobile devices that are communicatively coupled with the femtocell. The estimated location may be calculated as an arithmetic mean of reported location samples, a weighted mean of reported location samples, or by using reported location samples in conjunction with estimated distances and trilateration. The estimated location may be applied in geographic license checks, network interference checks and/or emergency call registration, for example.

### BACKGROUND OF THE INVENTION

The present invention relates to determining the geographic location of a device and, more particularly, to determining the geographic location of a femtocell.

A femtocell, sometimes called an access point base station, is a small wireless base station that is typically deployed in a home or small business environment. A femtocell usually connects to a backhoul service provider network via a broadband connection, such as a digital subscriber line (DSL) or cable modem connection.

It is important to know the geographic location of femtocells for a number of reasons. One reason is to avoid network interference. In a cellular network, multiple base stations may transmit on a common frequency and interference is avoided by having enough space between them. Regulating the location of femtocells can thus prevent unwanted reductions in network capacity and quality of service. Another reason is to enable the location where emergency calls have been placed to be automatically identified. Yet another reason is to enforce geographic license restrictions. For example, a femtocell may be licensed for use only within a particular region or site and it may be desirable to prevent use within other regions or sites.

One known way to discover the geographic location of a femtocell is through manual registration of the location by the user. This approach has several limitations. For example, the user may fail to register the location or enter an erroneous location. Moreover, if a femtocell is moved the user may fail to update the registered location.

Another known way to discover the geographic location of a femtocell is to integrate into the femtocell a Global Positioning System (GPS) receiver that acquires its location using signals received from GPS satellites. However, GPS integration adds cost to the femtocell. Moreover, since a femtocell is typically installed in a building, it may have difficulty receiving GPS signals.

### SUMMARY OF THE INVENTION

In a basic feature, the present invention provides methods and systems by which a femtocell acquires its geographic location using location samples reported by mobile devices that are communicatively coupled with the femtocell. The estimated location may be calculated as an arithmetic mean of reported location samples, a weighted mean of reported location samples, or by using reported location samples in conjunction with estimated distances and trilateration. The estimated location may be applied in geographic license checks, network interference checks and/or emergency call registration, for example.

In one aspect of the invention, a femtocell comprises a radio interface and a processor communicatively coupled with the radio interface, wherein under control of the processor the femtocell calculates an estimated location of the femtocell using location samples received via the radio interface from mobile devices communicatively coupled with the femtocell.

In some embodiments, under control of the processor the femtocell calculates the estimated location as an arithmetic mean of the location samples.

In some embodiments, under control of the processor the femtocell calculates the estimated location as a weighted mean of the location samples.

In some embodiments, the location samples are weighted using values associated with the location samples indicative of distances between the femtocell and the mobile devices.

In some embodiments, the location samples are weighted using received signal strength indications (RSSI) associated with the location samples.

In some embodiments, the location samples are weighted using channel quality indices (CQI) associated with the location samples.

In some embodiments, the location samples comprise at least three location samples and the femtocell under control of the processor calculates the estimated location using estimated distances between the femtocell and the mobile devices and trilateration.

In some embodiments, the estimated distances are calculated using an estimated transit power for the femtocell, a predetermined propagation model and RSSI.

In some embodiments, the location samples are received from the mobile devices in response to location requests issued via the radio interface under control of the processor by the femtocell.

In some embodiments, the location samples are received from the mobile devices periodically.

In some embodiments, the location samples are received from the mobile devices in response to acquisition of location by the mobile devices.

In some embodiments, under control of the processor the femtocell excludes from the estimated location calculation location samples received via the radio interface from unauthorized devices.

In some embodiments, under control of the processor the femtocell excludes from the estimated location calculation out-of-range location samples received via the radio interface.

In some embodiments, under control of the processor the femtocell detects a power-up event and in response determines whether the femtocell has been relocated and selectively recalculates based on whether the femtocell has been relocated the estimated location of the femtocell using location samples received after the power-up event via the radio interface from mobile devices communicatively coupled with the femtocell.

In some embodiments, under control of the processor the femtocell applies the estimated location in a geographic license check.

In some embodiments, under control of the processor the femtocell applies the estimated location in an interference check.

In some embodiments, under control of the processor the femtocell applies the estimated location in emergency call registration.

In another aspect of the invention, a method for estimating the location of a femtocell comprises the steps of receiving on the femtocell from mobile devices location samples and calculating using the location samples an estimated location of the femtocell.

In some embodiments, the calculating step is performed on the femtocell.

In some embodiments, the calculating step is performed on a femtocell location management entity (FLME) to which the location samples are transmitted by the femtocell.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the present invention is operative in some embodiments.

FIG. 2 shows a representative mobile device with which the present invention is operative in some embodiments.

FIG. 3 shows operational elements of a representative mobile device with which the present invention is operative in some embodiments.

FIG. 4 shows the femtocell of FIG. 1 in more detail.

FIG. 5 shows operational elements of the femtocell of FIG. 1 in more detail.

FIG. 6 illustrates a method for estimating a location of a femtocell in some embodiments of the invention.

FIG. 7 illustrates a method for performing a relocation check on a femtocell after power-up in some embodiments of the invention.

FIG. 8 illustrates a method for applying an estimated location of a femtocell in some embodiments of the invention.

### DETAILED DESCRIPTION OF A PREFERRED EMBODIMENT

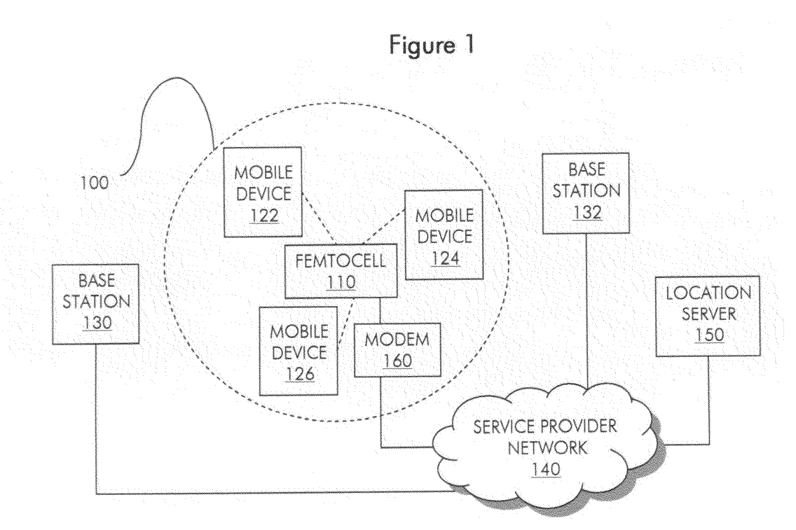

In FIG. 1, a communication system in which the present invention is operative in some embodiments is shown. The communication system includes a femtocell 110 that is communicatively coupled to a service provider network 140 via a modem 160, such as a DSL or cable modem. Femtocell 110 may, for example, have a wired Ethernet link to modem 160, which in turn has a cable or DSL connection to service provider network 140. Femtocell 110 has a limited coverage area 100 within which reside mobile devices 122, 124, 126 that are communicatively coupled with femtocell 100 via wireless links, such as Universal Mobile Telecommunications System (UMTS), Code Division Multiple Access 2000 (CDMA2000), Time Division Synchronous Code Division Multiple Access (TD-SCDMA) or Worldwide Interoperability for Microwave Access (WiMA) links. Femtocell 110 provides an access point through which mobile devices 122, 124, 126 within coverage area 100 can communicate (e.g. via voice calls, text messaging, etc.) with other devices that are reachable via service provider network 140. Outside of coverage area 100 reside traditional base stations 130, 132 and a location server 150 that are also communicatively coupled with service provider network 140 via wired connections. In some embodiments, femtocell 110 resides within a commercial or residential building, such as an office building, house, condominium complex or apartment complex.

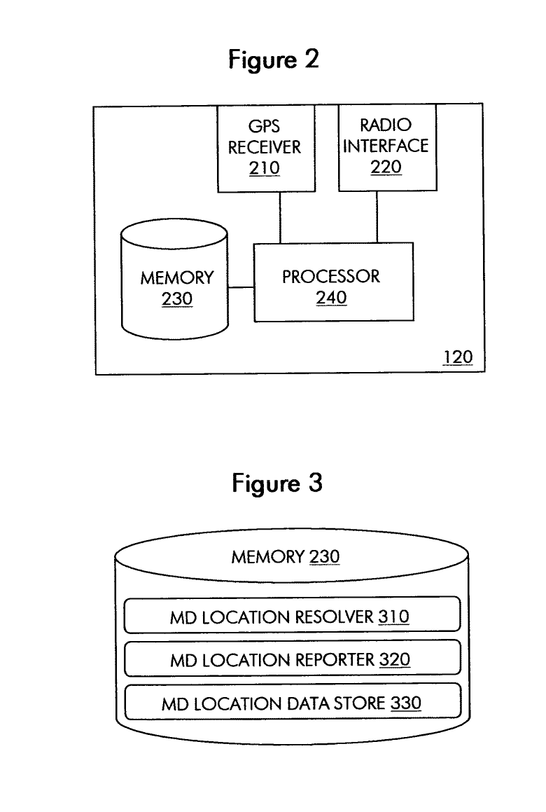

Turning to FIG. 2, a mobile device 120, which is representative of mobile devices 122, 124, 126, is shown in some embodiments to include a GPS receiver 210, a radio interface 220 and a memory 230, all of which are communicatively coupled with a processor 240. GPS receiver 210 receives GPS signals from GPS satellites and passes GPS signals to processor 240. Radio interface 220 provides connectivity between mobile device 120 and femtocell 110 via a wireless link, such as a UMTS, CDMA2000, TD-SCDMA or WiMAX link. Processor 240 executes in software operations supported by mobile device 120, including establishment, tear-down and management of wireless links via radio interface 220 and generating and transmitting to femtocell 110 via radio interface 220 location reports having location samples. Memory 230 stores software executable by processor 240 and location samples. Memory 230 includes one or more random access memory (RAM) and one or more read only memory (ROM) elements.

FIG. 3 shows operational elements of mobile device 120 stored in memory 230 to include mobile device (MD) location resolver 310, MD location reporter 320 and MD location data store 330. MD location resolver 310 and MD location reporter 320 are software programs executable by processor 240.

In some embodiments, MD location resolver 310 decodes GPS signals received from GPS receiver 210, determines using GPS signals location samples each having at least latitude and longitude coordinates and stores location samples in MD location data store 330. In other embodiments, mobile device 120 invokes assisted GPS. In these embodiments, MD location resolver 310 transmits GPS signals received from GPS receiver 210 to well-known location server 150 via radio interface 220 where the GPS signals are combined with GPS information received from base stations 130, 132 to generate location samples calculated using base station triangulation that are returned by location server 150 via radio interface 220 and stored by MD location resolver 310 in MD location data store 330. It bears noting that mobile device 120, due to its mobility, generally has numerous opportunities to receive GPS signals even when disposed inside of a building.

MD location reporter 320 generates and transmits to femtocell 110 via radio interface 220 location reports having location samples and other information. In some embodiments, location reports are generated and transmitted in response to a broadcast, multicast or unicast location report request received from femtocell 110 via radio interface 220. In other embodiments, location reports are generated and transmitted periodically. In still other embodiments, location reports are generated and transmitted upon first acquisition of GPS signals or initial discovery of femtocell 110. Location reports each have information sufficient to identify mobile device 120, such as unique address and/or device identifier, and a location sample retrieved from MD location data store 330 that includes at least latitude and longitude coordinates. In the event a valid location sample is unavailable, such unavailability is indicated in the location report by, for example, setting an invalid location flag or transmitting an invalid location symbol that will be recognized by femtocell 110. Other information transmitted in location reports may include, for example, a RSSI and/or a CQI.

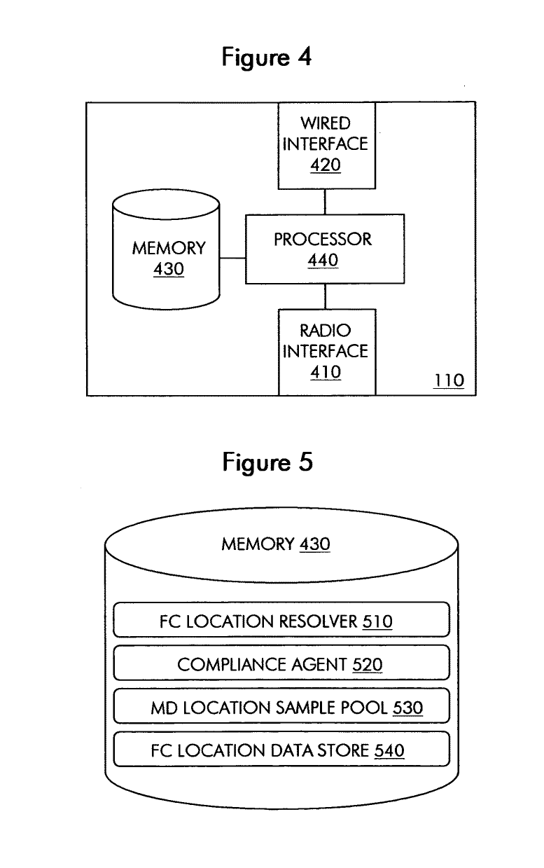

In FIG. 4 femtocell 110 is shown in some embodiments to include a radio interface 410, a wired interface 420 and a memory 430, all of which are communicatively coupled with a processor 440. Radio interface 410 provides connectivity between femtocell 110 and mobile devices 122, 124, 126 (of which mobile device 120 is representative) on wireless links, such as a UMTS, CDMA2000, TD-SCDMA or WiMAX links. Wired interface 420 provides wired connectivity between femtocell 110 and devices accessible via service provider network 140. In some embodiments, wired interface 420 connects to a DSL or cable modem 160 via a wired Ethernet link, and modem 160 in turn connects to service provider network 140 via a DSL line or cable modem connection. Processor 440 executes in software operations supported by femtocell 110, including establishment, tear-down and management of wireless links via radio interface 410 and a wired link via wired interface 420, receiving from mobile devices 122, 124, 126 via radio interface 410 and processing location reports having location samples to generate an estimated location of femtocell 110, and applying the estimated location of femtocell 110 in one or more applications. Memory 430 stores software executable by processor 440, reported location samples and the estimated location of femtocell 110. Memory 430 includes one or more RAM elements and one or more ROM elements.

FIG. 5 shows operational elements of femtocell 110 stored in memory 430 to include femtocell (FC) location resolver 510, compliance agent 520, MD location sample pool 530 and FC location data store 540. FC location resolver 510 and compliance agent 520 are software programs executable by processor 440.

FC location resolver 510 receives location reports from mobile clients 122, 124, 126 via radio interface 410, processes the location reports and generates an estimated location of femtocell 110 using location samples and other information in the location reports. In some embodiments, location reports are received in response to broadcast, multicast or unicast location report requests generated and transmitted by femtocell 110 via radio interface 410. In other embodiments, location reports are received from each of mobile clients 122, 124, 126 periodically. In still other embodiments, location reports are received from each of mobile clients 122, 124, 126 in response to their first acquisition of GPS signals or initial discovery of femtocell 110. In some embodiments, FC location resolver 510 indicates in a broadcast location report request whether all or only a subset of mobile devices 122, 124, 126 should submit a location report by, for example, setting a reporting group flag or transmitting a reporting group symbol that will be recognized by mobile devices 122, 124, 126. For example, in some embodiments, one or more of mobile devices 122, 124, 126 may not be authorized to transmit or receive calls via femtocell 110. FC location resolver 510 may indicate in a broadcast location report request whether such devices are authorized to submit a location report by setting a flag or transmitting a symbol in a well-known field within the location report request.

FC location resolver 510 selectively adds location samples received in location reports to MD location sample pool 530 and calculates an estimated location of femtocell 110 once the number of location samples in pool 530 reaches a minimum threshold number. FC location resolver 510 stores the estimated location of femtocell 110 in FC location data store 540. FC location resolver 510 updates the estimated location as additional location samples are received and applied in the calculation.

FC location resolver 510 may invoke any of numerous schemes to calculate an estimated location of femtocell 110. In some embodiments, FC location resolver 510 calculates an estimated location as an arithmetic mean of the location samples in MC location sample pool 530. In these embodiments, once a minimum threshold number of location samples have been added to pool 530, an estimated location is calculated as:

$$( \overline{x} , \overline{y} ) = ( \frac{{\sum }_{i = 1}^{n} {x}_{i}}{n} , \frac{{\sum }_{i = 1}^{n} {y}_{i}}{n} )$$

where n is the total number of location samples and (xᵢ, yᵢ) is the two-dimensional geoposition (e.g. longitude, latitude) of the ith location sample. The estimated location is updated thereafter every time a new sample is added to pool 530.

In other embodiments, FC location resolver 510 calculates an estimated location of femtocell 110 as a weighted mean of the location samples in pool 530. These embodiments assume that a location sample from a mobile device that is closer to femtocell 110 should have more weight in determining an estimated location. In these embodiments, after a minimum threshold number of location samples have been added to pool 530, an estimated location is calculated as:

$$( \overline{x} , \overline{y} ) = ( \frac{{\sum }_{i = 1}^{n} {w}_{i} {x}_{i}}{{\sum }_{i = 1}^{n} {w}_{i}} , \frac{{\sum }_{i = 1}^{n} {w}_{i} {y}_{i}}{{\sum }_{i = 1}^{n} {w}_{i}} )$$

where n is the total number of location samples, (xᵢ, yᵢ) is the two-dimensional geoposition (e.g. longitude, latitude) of the ith location sample, and wᵢ is a location sample weight that is inversely related to an estimated distance of the reporting one of mobile devices 122, 124, 126 to femtocell 110. For purposes of assigning a weight to a location sample, distance may be estimated by reference to one or more values reported along with the location sample (and stored in association with the location sample in pool 530) that are indicative of the quality of the signal that the reporting mobile device receives from femtocell 110. Such values may include, for example, RSSI and/or CQI.

In still other embodiments, FC location resolver 510 calculates an estimated location using estimated distances between femtocell 110 and mobile devices 122, 124, 126 and trilateration. In these embodiments, FC location resolver 510 generates three or more <location, distance> pairs using information from at least three location reports. More particularly, for each of at least three location reports, FC location resolver 510 estimates a distance between femtocell 110 and the reporting one of mobile devices 122, 124, 126 based on estimated transit power of femtocell 110, a predetermined propagation model and an RSSI reported in the location report along with a location sample (and stored in association with the location sample in pool 530) to produce at least three <location, distance> pairs. FC location resolver 510 then applies the three or more <location, distance> pairs to estimate its location using trilateration. In some embodiments, reporting mobile devices 122, 124, 126 report CQI as well, and FC location resolver 510 excludes location samples having CQI that are below a minimum threshold to improve the reliability of the estimated location calculation.

Once an estimated location of femtocell 110 has been computed and stored in FC location data store 540, compliance agent 520 may apply the estimated location in location-based services, such as a network non-interference verification service, a geographic license verification service and/or emergency call registration service.

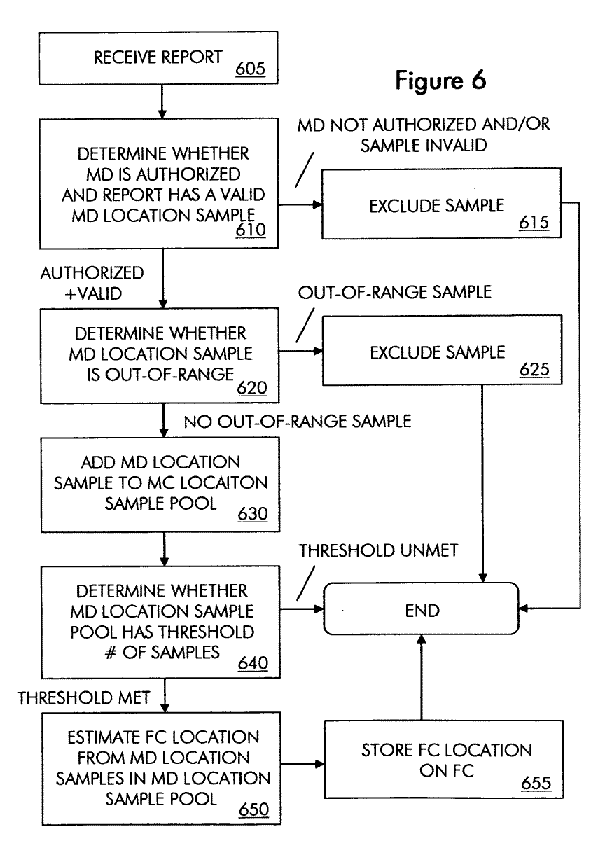

FIG. 6 illustrates a method for estimating a location of femtocell 110 in some embodiments of the invention. Femtocell 110 receives a location report from one of mobile devices 122, 124, 126 (605). FC location resolver 510 determines whether the mobile device is authorized to report location samples and whether the report includes a valid location sample (610). If the mobile device is not authorized to report location samples or the report includes an invalid location sample, FC location resolver 510 excludes the sample (615). Exclusion of the sample may involve, for example, discarding the location report without adding the location sample from the location report to MD location sample pool 530. If, on the other hand, the mobile device is authorized to report location samples and the report includes a valid location sample, FC location resolver 510 determines whether the location sample is out-of-range (620). In this regard, FC location resolver 510 may compare the location sample with location samples in pool 530 and exclude the location sample if it is geographically apart from the location samples in pool 530 by more than a predetermined distance. If the location sample is out-of-range, FC location resolver 510 excludes the sample (625). If, on the other hand, the location sample is within range, FC location resolver 510 adds the location sample to pool 530 (630) and determines whether pool 530 has a minimum threshold number of location samples (640). If pool 530 does not have a minimum threshold number of location samples, the flow terminates at that point. If, however, pool 530 has a minimum threshold number of location samples, FC location resolver 510 calculates an estimated location of femtocell 110 using the location samples from pool 530 (650). The estimated location may be calculated, for example, as an arithmetic mean, a weighted mean or using trilateration in conjunction with estimated distances. Finally, FC location resolver 510 stores the estimated location of femtocell 110 in FC location data store 540 (655), replacing any earlier calculated estimated location.

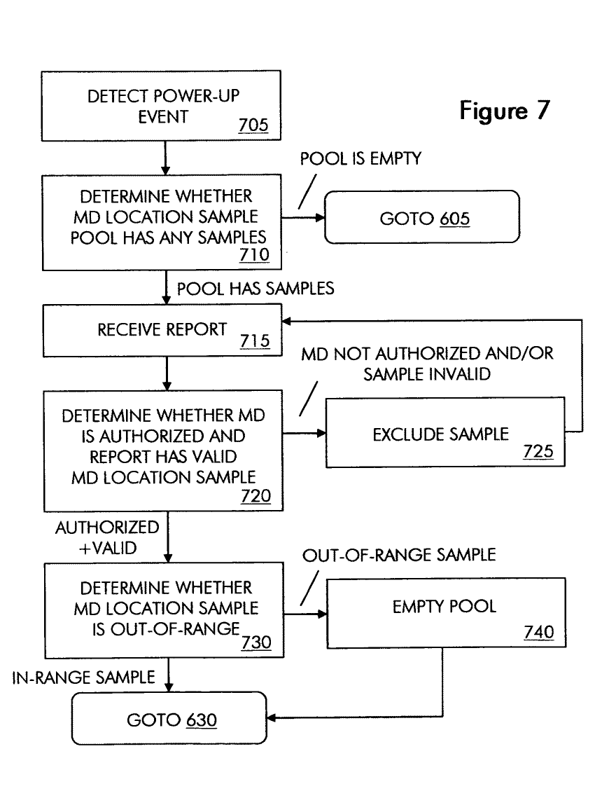

FIG. 7 illustrates a method for performing a relocation check on femtocell 110 after power-up in some embodiments of the invention. Such a relocation check is desirable since if femtocell 110 has been moved the location samples in pool 530 may no longer be reliable and in that event must be excluded from further calculations of estimated location. FC location resolver 510 detects a power-up event (705) and determines whether MD location sample pool 530 has any samples (710). If pool 530 is empty, there is no risk of using unreliable samples and the flow reverts to Step 605. If, however, pool 530 has samples, the flow continues within FIG. 7 and when the next location report is received from one of mobile devices 122, 124, 126 (715), FC location resolver 510 determines whether the mobile device is authorized to report location samples and whether the report includes a valid location sample (720). If the mobile device is not authorized to report location samples or the report includes an invalid location sample, FC location resolver 510 excludes the location sample (725) and femtocell 110 waits for another location report. If, on the other hand, the mobile device is authorized to report location samples and the report includes a valid location sample, FC location resolver 510 determines whether the location sample is out-of-range (730). In this regard, FC location resolver 510 may compare the location sample from the location report with location samples in pool 530 and determine whether the location sample from the report is out-of-range based on whether it is geographically separated from the location samples in pool 530 by more than a predetermined distance. If the location sample from the report is within range, it is assumed that femtocell 110 has not been relocated and the flow moves to Step 630 without discarding the location samples in pool 530. If, however, the location sample from the report is out-of-range, it is assumed that femtocell 110 has been relocated and FC location resolver 510 discards the location samples in pool 530 (740) before proceeding to Step 630.

In other embodiments, FC location resolver 510 may discard the location samples in pool 530 upon detecting a power-up event without assessing whether femtocell 110 has been relocated.

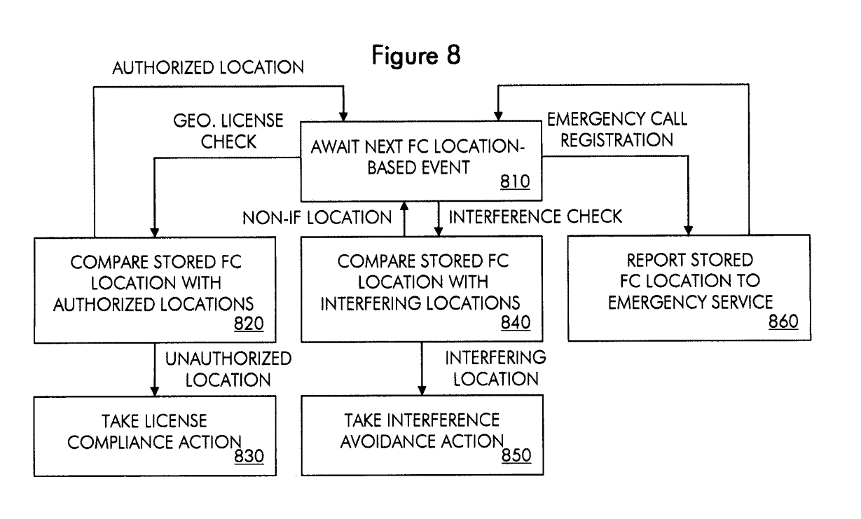

FIG. 8 illustrates a method for applying an estimated location of femtocell 110 in some embodiments of the invention. In these embodiments, compliance agent 520 begins in a listening state wherein compliance agent 520 awaits the next FC location-based event (810). If the event is a geographic license check, compliance agent 520 compares the estimated location of femtocell 10 stored in FC location data store 540 with a range of authorized locations (820). If the estimated location is authorized, compliance agent 520 returns to a listening state without taking a compliance action (810). If, however, the estimated location is unauthorized, compliance agent 520 takes a compliance action (830). Taking a compliance action may involve, for example, reporting a violation of geographic license to a licensing management device on service provider network 140 and/or deactivating femtocell 110. If the event is a network interference check, compliance agent 520 compares the estimated location of femtocell 110 stored in FC location data store 540 with a range of interfering locations (840). If the estimated location is non-interfering, compliance agent 520 returns to a listening state without taking an interference avoidance action (810). If, however, the estimated location is interfering, compliance agent 520 takes an interference avoidance action (850). Taking an interference avoidance action may involve, for example, reporting the interference to a network management device on service provider network 140, enforcing an automatic reduction in the transit power of femtocell 110, enforcing an automatic change of the transmission frequency of femtocell 100 and/or deactivating femtocell 110. Finally, if the event is emergency call registration, compliance agent 520 reports the estimated location of femtocell 110 stored in FC location data store 540 to an emergency call management device on service provider network 140 (860).

It will be appreciated by those of ordinary skill in the art that the invention can be embodied in other specific forms without departing from the spirit or essential character hereof. For example, in some embodiments, all or part of the functions of FC location resolver 510 may be offloaded from femtocell 110 and performed by a remote FLME that on service provider network 140. In some of these embodiments, mobile devices 122, 124, 126 communicate with the remote FLME in a manner that is transparent to femtocell 110. In other of these embodiments, femtocell 110 has software executable thereon to preprocess location reports (such as verifying that the reporting mobile device is authorized and that the report includes a valid location sample) and relay preprocessed location reports or information therefrom to the remote FLME. Moreover, in these embodiments the remote FLME may detect a loss of a logical connection with femtocell 110 and, upon such detection, discard location samples received from mobile devices 122, 124, 126 to avoid using unreliable location samples in calculating an estimated location of femtocell 110. Furthermore, in these embodiments the remote FLME may perform all or port of the functions of compliance agent 520, such as performing geographic license checks, interference checks and emergency call registration and taking necessary compliance actions.

The present description is therefore considered in all respects to be illustrative and not restrictive. The scope of the invention is indicated by the appended claims, and all changes that come with in the meaning and range of equivalents thereof are intended to be embraced therein.

What is claimed is:

1. A femtocell, comprising:
a radio interface; and
a processor communicatively coupled with the radio interface, wherein under control of the processor the femtocell calculates an estimated location of the femtocell using location samples received via the radio interface from mobile devices communicatively coupled with the femtocell.

2. The femtocell of claim 1, wherein under control of the processor the femtocell calculates the estimated location as an arithmetic mean of the location samples.

3. The femtocell of claim 1, wherein under control of the processor the femtocell calculates the estimated location as a weighted mean of the location samples.

4. The femtocell of claim 1, wherein the location samples are weighted using values associated with the location samples indicative of distances between the femtocell and the mobile devices.

5. The femtocell of claim 1, wherein the location samples are weighted using received signal strength indications (RSSI) associated with the location samples.

6. The femtocell of claim 1, wherein the location samples are weighted using channel quality indices (CQI) associated with the location samples.

7. The femtocell of claim 1, wherein the location samples comprise at least three location samples and the femtocell under control of the processor calculates the estimated location using estimated distances between the femtocell and the mobile devices and trilateration.

8. The femtocell of claim 7, wherein the estimated distances are calculated using an estimated transit power for the femtocell, a predetermined propagation model and RSSI.

9. The femtocell of claim 1, wherein the location samples are received from the mobile devices in response to location requests issued via the radio interface under control of the processor by the femtocell.

10. The femtocell of claim 1, wherein the location samples are received from the mobile devices periodically.

11. The femtocell of claim 1, wherein the location samples are received from the mobile devices in response to acquisition of location by the mobile devices.

12. The femtocell of claim 1, wherein under control of the processor the femtocell excludes from the estimated location calculation location samples received via the radio interface from unauthorized devices.

13. The femtocell of claim 1, wherein under control of the processor the femtocell excludes from the estimated location calculation out-of-range location samples received via the radio interface.

14. The femtocell of claim 1, wherein under control of the processor the femtocell detects a power-up event and in response determines whether the femtocell has been relocated and selectively recalculates based on whether the femtocell has been relocated the estimated location of the femtocell using location samples received after the power-up event via the radio interface from mobile devices communicatively coupled with the femtocell.

15. The femtocell of claim 1, wherein under control of the processor the femtocell applies the estimated location in a geographic license check.

16. The femtocell of claim 1, wherein under control of the processor the femtocell applies the estimated location in on interference check.

17. The femtocell of claim 1, wherein under control of the processor the femtocell applies the estimated location in emergency call registration.

18. A method for estimating the location of a femtocell, comprising the steps of:
receiving on the femtocell from mobile devices location samples; and
calculating using the location samples an estimated location of the femtocell.

19. The method of claim 18, wherein the calculating step is performed on the femtocell.

20. The method of claim 18, wherein the calculating step is performed on a femtocell location management entity (FLME) to which the location samples are transmitted by the femtocell.
